(19) United States
(12) Patent Application Publication
(10) Pub. No.: US 2025/0214373 A1
(43) Pub. Date: Jul. 3, 2025

(54) VEHICLE TIRE CHANGE KIT

(71) Applicant: Clyde McCartney, Ortonville, MN (US)

(72) Inventor: Clyde McCartney, Ortonville, MN (US)

(21) Appl. No.: 18/398,959

(22) Filed: Dec. 28, 2023

(51) Int. Cl. B60B 29/00; B66F 3/08

(52) U.S. Cl. CPC B60B 29/006; B66F 3/08

(57) ABSTRACT

A vehicle tire change kit includes a hydraulic jack that has an input socket and a lifting plate. The lifting plate is raised or lowered when the input socket is rotated in a respective first direction or second direction to jack a vehicle. An impact driver is provided that has an output chuck which is matable to the input socket of the hydraulic jack for rotating the input socket in either the first direction or the second direction. A plurality of impact sockets is provided to engage lug nuts on a respective tire on the vehicle for removing the respective tire from the vehicle. A jack stand is included for safely retaining the vehicle in a jacked position and a pair of wheel chocks are provided to inhibit a respective wheel from rolling when the vehicle is being jacked.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tire change devices and more particularly pertains to a new tire change device for changing a tire on a vehicle. The device includes a hydraulic jack, an impact driver, a jack stand, a battery charger, a plurality of impact sockets and a pair of wheel chocks. The hydraulic jack has an input socket that is matable to an output chuck on the impact driver for lifting or lowering a vehicle with the hydraulic jack. Additionally, a respective one of the impact sockets can be mated to the impact driver for removing lug nuts from a tire of the vehicle for changing the tire.

### (2) Description of Related Art Including Information Disclosed Under 37 CFR 1.97 and 1.98

The prior art relates to tire change devices including a variety of impact drivers that are designed for removing lug nuts from tires and a variety of tire changing kits that each at least includes an impact driver and a hydraulic jack to which the impact driver is matable for jacking a vehicle. In no instance does the prior art disclose a tire changing device that includes an impact driver, a hydraulic jack to which the impact driver is matable for lifting a vehicle, a plurality of impact sockets, a battery charger, a jack stand and a pair of wheel chocks.

### BRIEF SUMMARY OF THE INVENTION

An embodiment of the disclosure meets the needs presented above by generally comprising a hydraulic jack that has an input socket and a lifting plate. The lifting plate is raised or lowered when the input socket is rotated in a respective first direction or second direction to jack a vehicle. An impact driver is provided that has an output chuck which is matable to the input socket of the hydraulic jack for rotating the input socket in either the first direction or the second direction. A plurality of impact sockets is provided to engage lug nuts on a respective tire on the vehicle for removing the respective tire from the vehicle. A jack stand is included for safely retaining the vehicle in a jacked position and a pair of wheel chocks are provided to inhibit a respective wheel from rolling when the vehicle is being jacked.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle tire change kit according to an embodiment of the disclosure.

FIG. 2 is a perspective view of an impact driver being mated to a hydraulic jack of an embodiment of the disclosure.

FIG. 3 is a perspective in-use view of an embodiment of the disclosure.

FIG. 4 is a perspective in-use view of an embodiment of the disclosure showing a battery charger being positioned within a vehicle.

FIG. 5 is a perspective in-use view of an embodiment of the disclosure showing a vehicle being jacked.

### DETAILED DESCRIPTION OF THE INVENTION

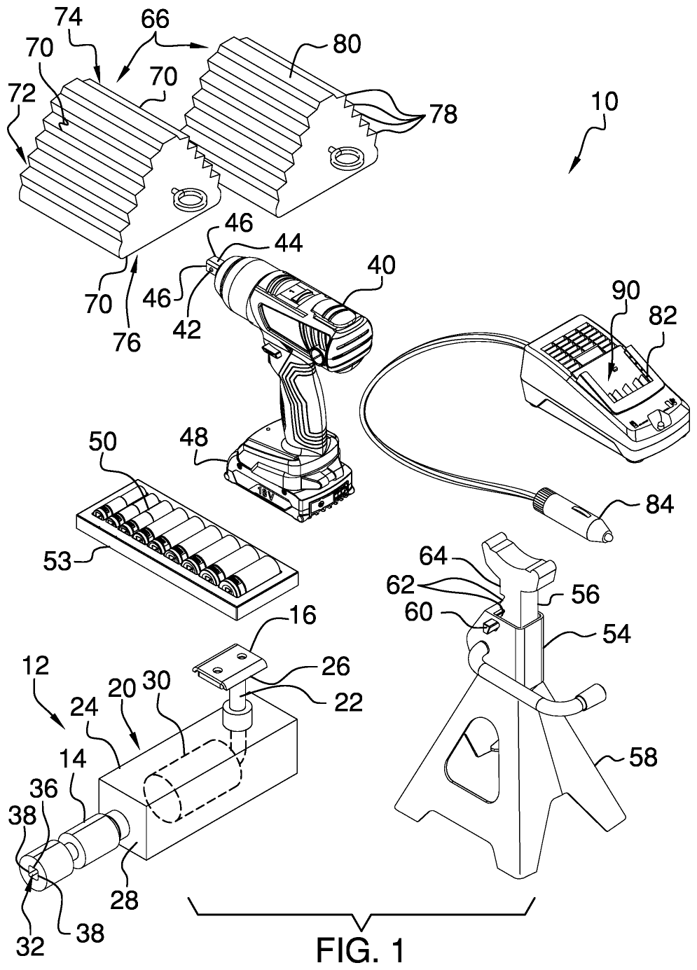

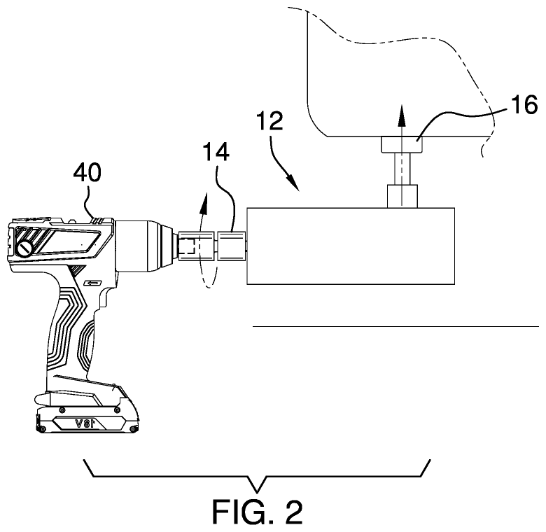

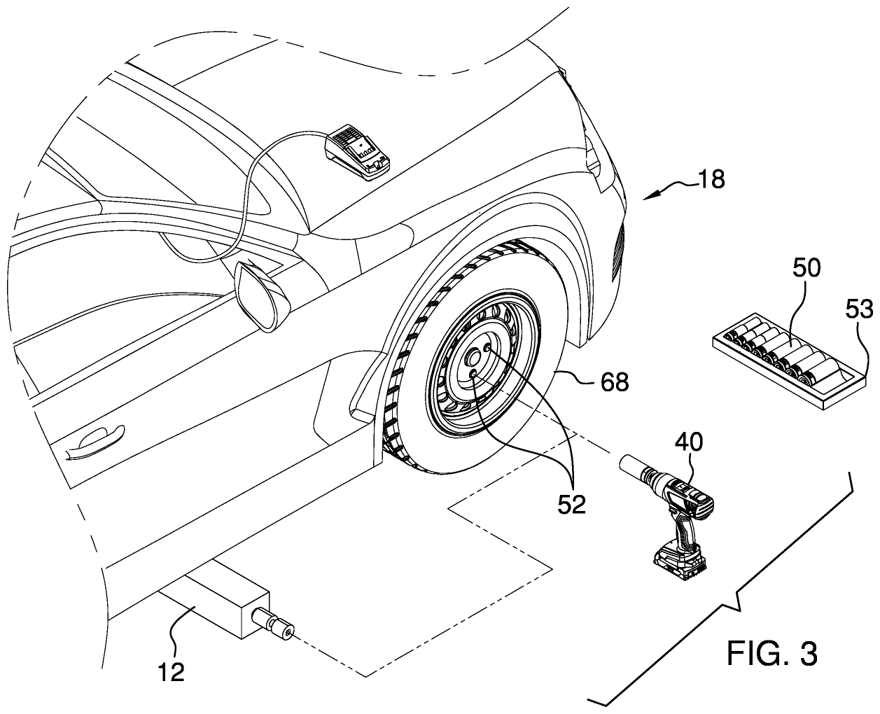

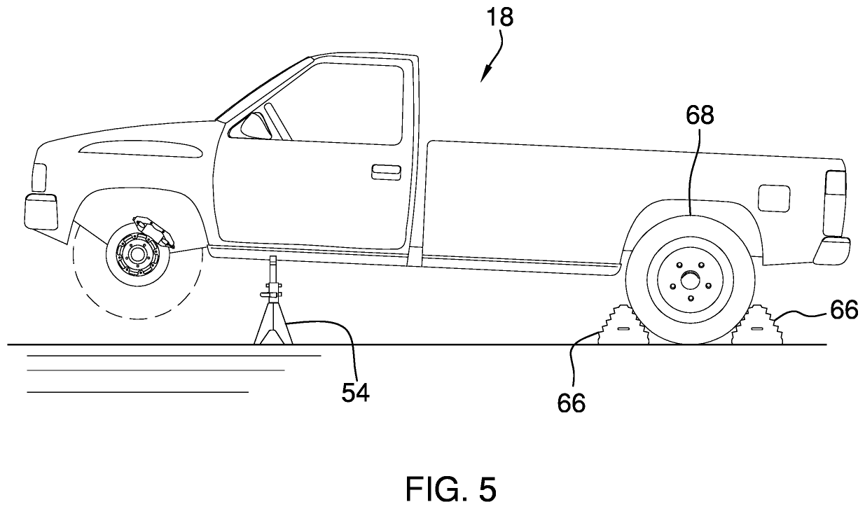

With reference now to the drawings, and in particular to FIGS. 1 through 5 thereof, a new tire change device embodying the principles and concepts of an embodiment of the disclosure and generally designated by the reference numeral 10 will be described.

As best illustrated in FIGS. 1 through 5, the vehicle tire change kit 10 generally comprises a hydraulic jack 12 that has an input socket 14 and a lifting plate 16. The lifting plate 16 is raised or lowered when the input socket 14 is rotated in a respective first direction or second direction to facilitate the hydraulic jack 12 to jack a vehicle 18. The vehicle 18 may be a passenger vehicle, a cargo vehicle, an all-terrain vehicle or any other type of motorized vehicle that has tires. The hydraulic jack 12 includes a housing 20 and a telescopic piston 22 extending upwardly from at top wall 24 of the housing 20; the lifting plate is attached to top end 26 of the telescopic piston 22.

The telescopic piston 22 lengthens when the input socket 14 is rotated in the first direction and the telescopic piston 22 shortens when the input socket 14 is rotated in the second direction. The input socket 14 is disposed on a front wall 28 of the housing 20 of the hydraulic jack 12 and the hydraulic jack might include hydraulic a pump 30 that is driven when the input socket 14 is rotated. Additionally, the input socket 14 has a well 32 extending into a distal end 34 of the input socket 14 with respect to the front wall 28 of the housing 20 and the well 32 has a bounding surface 36 which has a plurality of perpendicularly oriented sides 38 such that the well 32 has a rectangular shape.

An impact driver 40 is provided which has an output chuck 42 that is matable to the input socket 14 of the hydraulic jack 12 for rotating the input socket 14 in either the first direction or the second direction. The output chuck 42 has an exterior surface 44 which has a plurality of perpendicularly oriented sides 46 such that the output chuck 42 has a rectangular shape. In this way the output chuck 42 can conform to the shape of the well 32 in the distal end 34 of the input socket 14. Additionally, the impact driver 40 has a rechargeable battery 48 that is removably matable to the impact driver 40. The rechargeable battery 48 may comprise an 18.0 volt rechargeable battery and the impact driver 40 may have an output torque of at least 260.0 ft lb to facilitate the impact driver 40 to either break loose properly tightened lug nuts or to tighten lug nuts to the recommended torque value. Additionally, the output chuck 42 may be a 0.5 inch driver commonly associated with socket wrenches and the impact driver 40 may be a cordless impact wrench of any conventional design.

A plurality of impact sockets 50 is included and a respective one of the impact sockets 50 is releasably matable to the output chuck 42 of the impact driver 40. In this way the respective impact socket 50 can engage lug nuts 52 on a respective tire 68 on the vehicle 18 for removing the respective tire 68 from the vehicle 18. Each of the plurality of impact sockets 50 has a unique size with respect to each other to accommodate a wide range of sizes of lug nuts 52. Furthermore, each of the plurality of impact sockets 50 may be stored in a storage tray 53 or other type of carrying device. Each of the plurality of impact sockets 50 may be 0.5 inch sockets specifically designed for use with an impact wrench.

A jack stand 54 is provided which has a support member 56 that is retainable at a variety of heights. In this way the jack stand 54 can be positioned beneath the vehicle 18 when the vehicle 18 has been jacked for safely retaining the vehicle 18 in a jacked position. The jack stand 54 has a support frame 58 and a locking mechanism 60 that is movably integrated into the support frame 58. The support member 56 has a plurality of teeth 62 integrated into a rear surface 64 of the support member 56. The locking mechanism 60 releasably engages a respective one of the plurality of teeth 62 for retaining the support member 56 at a selected length with respect to the support frame 58. The jack stand 54 may be a jack stand of any conventional design that has a weight capacity of at least 900.0 kg.

A pair of wheel chocks 66 is provided and each of the pair of wheel chocks 66 is structured to have a triangular shape. In this way the pair of wheel chocks 66 can be positioned against a respective tire 68 on the vehicle 18 to inhibit the respective tire 68 from rolling when the vehicle 18 is being jacked. Each of the pair of wheel chocks 66 has a plurality of intersecting outer surfaces 70 is oriented acute angles with each other. The plurality of intersecting sides 70 of each of the pair of wheel chocks 66 includes a front side 72, a back side 74 and a bottom side 76. Each of the front side 76 and the back side 74 comprises a series of steps 78 that are evenly spaced apart from each other and are distributed between the bottom side 76 and a peak 80 defined by the front side 76 and the back side 74. In this way the series of steps 78 facilitate the respective tire 68 to frictionally engage either the front side 76 or the back side 74.

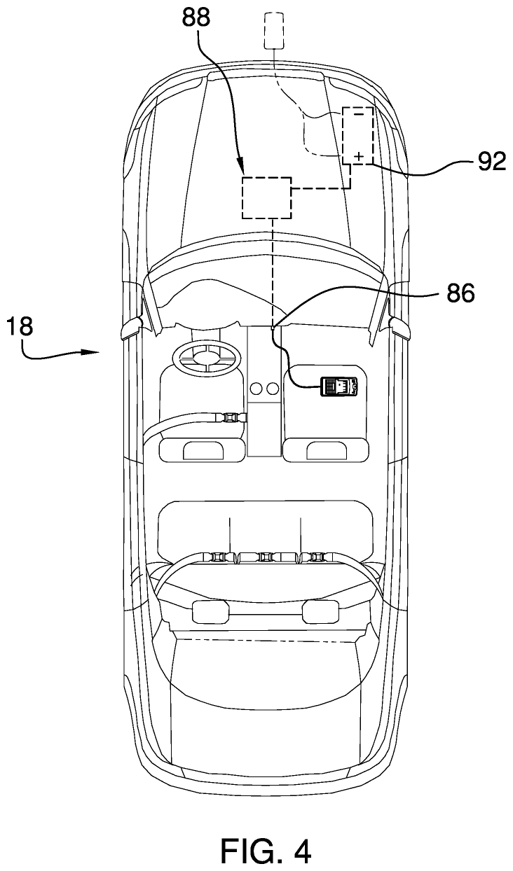

A charger 82 is provided which has a cigarette adapter 84 which can be plugged into a power port 86 in the vehicle 18 thereby facilitating the charger 82 to be in electrical communication with an electrical system 88 of the vehicle 18. The charger 82 has a charge port 90 which releasably engages the rechargeable battery 48 of the impact driver 40 for charging the rechargeable battery 48. Additionally, the charge port 90 is in electrical communication with the cigarette adapter 84 such that the charge port 90 is in electrical communication with the electrical system 88 of the vehicle 18. The charger 82 may be a cordless tool battery charger of any conventional design which is designed for charging 18.0 volt rechargeable batteries. As is shown in FIG. 4, the charger 82 might be electrically coupled to a battery 92 of the vehicle 18 rather than the power port 86 of the vehicle 18.

In use, each of the wheel chocks 66 is positioned against a respective tire 68 of the vehicle 18 and the hydraulic jack 12 is positioned beneath a jacking point 92 of the vehicle 18. The output chuck 42 on the impact driver 40 is inserted into the well 32 in the input socket 14 on the hydraulic jack 12. The impact driver 40 is actuated to rotate the input socket 14 in the first direction for jacking the vehicle 18. The jack stand 54 is positioned beneath the vehicle 18 to support the vehicle 18 thereby inhibiting the vehicle 18 from falling off of the hydraulic jack 12. The appropriate impact socket 50 is attached to the output chuck 42 on the impact driver 40 to facilitate the lug nuts 52 to be removed from a respective tire 68 when the respective tire 68 needs to be replaced. A replacement tire 68 is mounted to the vehicle 18 and the impact driver 40 is employed to tighten the lug nuts 52 on the replacement tire 68. The jack stand 54 is removed from beneath the vehicle 18 and the output chuck 42 is inserted into the well 32 in the input socket 14 of the hydraulic jack 12 to facilitate the hydraulic jack 12 to lower the vehicle 18. The wheel chocks 66 are removed from the respective tire 68 and the hydraulic jack 12, the jack stand 54, the wheel chocks 66 and the plurality of impact sockets 50 are placed in the vehicle 18 for storage.

With respect to the above description then, it is to be realized that the optimum dimensional relationships for the parts of an embodiment enabled by the disclosure, to include variations in size, materials, shape, form, function and manner of operation, kit and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle tire change kit for assisting with jacking a vehicle and changing a tire on the vehicle, said kit comprising:
a hydraulic jack having an input socket and a lifting plate, said lifting plate being raised or lowered when said input socket is rotated in a respective first direction or second direction wherein said hydraulic jack is configured to jack a vehicle;
an impact driver having an output chuck being matable to said input socket of said hydraulic jack for rotating said input socket in either said first direction or said second direction;
a plurality of impact sockets, a respective one of said impact sockets being releasably matable to said output chuck of said impact driver wherein said respective impact socket is configured to engage lug nuts on a respective tire on the vehicle for removing the respective tire from the vehicle, each of said plurality of impact sockets having a unique size with respect to each other wherein said plurality of impact sockets is configured to accommodate a wide range of sizes of lug nuts;
a jack stand having a support member being retainable at a variety of heights wherein said jack stand is configured to be positioned beneath the vehicle when the vehicle has been jacked for safely retaining the vehicle in a jacked position; and
a pair of wheel chocks, each of said pair of wheel chocks being structured to have a triangular shape wherein said pair of wheel chocks are configured to be positioned against a respective wheel on the vehicle to inhibit the respective wheel from rolling when the vehicle is being jacked.

2. The kit according to claim 1, wherein:
said hydraulic jack includes a housing and a telescopic piston extending upwardly from a top wall of said housing;
said lifting plate is attached to a top end of said telescopic piston;
said telescopic piston lengthens when said input socket is rotated in the first direction;
said telescopic piston shortening when said input socket is rotated in the second direction;
said input socket is disposed on a front wall of said housing;
said input socket has a well extending into a distal end of said socket with respect to said front wall of said housing; and
said well has a bounding surface which has a plurality of perpendicularly oriented sides such that said well has a rectangular shape.

3. The kit according to claim 2, wherein said output chuck of said impact driver has an exterior surface which has a plurality of perpendicularly oriented sides such that said output chuck has a rectangular shape thereby facilitating said output chuck to conform to the shape of said well in said distal end of said input socket.

4. The kit according to claim 1, wherein said jack stand has a support frame and a locking mechanism being movably integrated into said support frame, said support member having a plurality of teeth being integrated into a rear surface of said support member, said locking mechanism releasably engaging a respective one of said plurality of teeth for retaining said support member at a selected length with respect to said support frame.

5. The kit according to claim 1, wherein:
each of said pair of wheel chocks has a plurality of intersecting outer surfaces being oriented acute angles with each other;
said plurality of intersecting sides of each of said pair of wheel chocks includes a front side and a back side and a bottom side;
each of said front side and said back side comprises a series of steps being evenly spaced apart from each other and being distributed between said bottom side and a peak defined by said front side and said back side wherein said series of steps is configured to facilitate the respective wheel to frictionally engage either said front side or said back side.

6. The kit according to claim 1, wherein:
said kit includes a charger having a cigarette adapter wherein said cigarette adapter is configured to be plugged into a power port in the vehicle thereby facilitating said charger to be in electrical communication with an electrical system of the vehicle, said charger having a charge port which releasably engages said rechargeable battery of said impact driver for charging said rechargeable battery, said charge port being in electrical communication with said cigarette adapter wherein said charge port is configured to be in electrical communication with the electrical system of the vehicle; and
said impact driver has a rechargeable battery being removably matable to said impact driver.

7. A vehicle tire change kit for assisting with jacking a vehicle and changing a tire on the vehicle, said kit comprising:
a hydraulic jack having an input socket and a lifting plate, said lifting plate being raised or lowered when said input socket is rotated in a respective first direction or second direction wherein said hydraulic jack is configured to jack a vehicle, said hydraulic jack including a housing and a telescopic piston extending upwardly from a top wall of said housing, said lifting plate being attached to a top end of said telescopic piston, said telescopic piston lengthening when said input socket is rotated in the first direction, said telescopic piston shortening when said input socket is rotated in the second direction, said input socket being disposed on a front wall of said housing, said input socket having a well extending into a distal end of said socket with respect to said front wall of said housing, said well having a bounding surface which has a plurality of perpendicularly oriented sides such that said well has a rectangular shape;
an impact driver having an output chuck being matable to said input socket of said hydraulic jack for rotating said input socket in either said first direction or said second direction, said output chuck having an exterior surface which has a plurality of perpendicularly oriented sides such that said output chuck has a rectangular shape thereby facilitating said output chuck to conform to the shape of said well in said distal end of said input socket, said impact driver having a rechargeable battery being removably matable to said impact driver;
a plurality of impact sockets, a respective one of said impact sockets being releasably matable to said output chuck of said impact driver wherein said respective impact socket is configured to engage lug nuts on a respective tire on the vehicle for removing the respective tire from the vehicle, each of said plurality of impact sockets having a unique size with respect to each other wherein said plurality of impact sockets is configured to accommodate a wide range of sizes of lug nuts;
a jack stand having a support member being retainable at a variety of heights wherein said jack stand is configured to be positioned beneath the vehicle when the vehicle has been jacked for safely retaining the vehicle in a jacked position, said jack stand having a support frame and a locking mechanism being movably integrated into said support frame, said support member having a plurality of teeth being integrated into a rear surface of said support member, said locking mechanism releasably engaging a respective one of said plurality of teeth for retaining said support member at a selected length with respect to said support frame;
a pair of wheel chocks, each of said pair of wheel chocks being structured to have a triangular shape wherein said pair of wheel chocks are configured to be positioned against a respective wheel on the vehicle to inhibit the respective wheel from rolling when the vehicle is being jacked, each of said pair of wheel chocks having a plurality of intersecting outer surfaces being oriented acute angles with each other, said plurality of intersecting sides of each of said pair of wheel chocks including a front side and a back side and a bottom side, each of said front side and said back side comprising a series of steps being evenly spaced apart from each other and being distributed between said bottom side and a peak defined by said front side and said back side wherein said series of steps is configured to facilitate the respective wheel to frictionally engage either said front side or said back side; and
a charger having a cigarette adapter wherein said cigarette adapter is configured to be plugged into a power port in the vehicle thereby facilitating said charger to be in electrical communication with an electrical system of the vehicle, said charger having a charge port which releasably engages said rechargeable battery of said impact driver for charging said rechargeable battery, said charge port being in electrical communication with said cigarette adapter wherein said charge port is configured to be in electrical communication with the electrical system of the vehicle.
